(19) United States
(12) Patent Application Publication
(10) Pub. No.: US 2010/0224091 A1
(43) Pub. Date: Sep. 9, 2010

(54) TRAILING EDGE PATTERN FOR RELIEF PLATE FEATURE

(76) Inventor: Gregory L. Zwadlo, River Falls, WI (US)

Correspondence Address: Amelia A. Buharin;Patent Legal Staff, Eastman Kodak Company, 343 State Street, Rochester, NY, 14650-2201, US

(21) Appl. No.: 12/399,198

(22) Filed: Mar. 6, 2009

(51) Int. Cl. B41C 3/08

(52) U.S. Cl. 101/401.1

(57) ABSTRACT

An improved relief printing plate and method for producing said plate is disclosed. Disabling a pattern of halftone pixels associated with the trailing edge of a full tone image feature reduces the likelihood that a trailing edge inking void will be present when the relief plate is inked by a printing press.

### FIELD OF THE INVENTION

The present invention pertains to relief printing and in particular to improving the printability of solid relief features.

### BACKGROUND OF THE INVENTION

Flexography, which is one example of relief printing, produces an image on a substrate by transferring ink from the surface of a relief plate, representing the image, directly to the substrate. Relief features in a flexographic plate are typically formed by subjecting a plate precursor to a curing radiation (e.g. ultraviolet light) through an image-wise mask and then developing the precursor to wash away parts of the plate that have not received sufficient curing radiation. The resulting relief features typically comprise solid areas and halftone dots of varying sizes and/or quantities per area to represent a range of tones specified by the image data. For example, a highlight tone can be represented by an array of very small relief dots in an area, a shadow tone can be represented by an array of large dots in an area, and a full tone can be represented by a solid relief area.

FIG. 1 is a diagram illustrating an exemplary relief printing press according to the prior art. It depicts a simplified model of a printing press 1 that includes an inking reservoir 6 supplying ink to an inking roller 7. In flexographic presses, inking roller 7 usually comprises an anilox roller with a fine pattern of ink-carrying cells to facilitate transfer of ink from inking reservoir 6 to printing plate 5. Printing plate 5 is either an integral part of or mounted on printing cylinder 4 with the relief surface of printing plate 5 in contact with inking roller 7 and printing medium 2. Contact pressure between printing medium 2 and printing plate 5 is established by impression cylinder 8. Inking roller 7, printing cylinder 4, and impression cylinder 8 rotate as indicated in the diagram to effect a printing direction 3 for printing medium 2.

The orientation of printing plate 5 on the plate cylinder 4 and the printing direction 3 of the press determine, for any given relief feature, the directionality of contact between printing plate 5 and both inking roller 7 and printed medium 2. In particular, for any given relief feature, one can consider that there are leading and trailing edges of contact. The leading edge is the one that first makes contact with the inking roller 7 or printing medium 2. Similarly, the trailing edge is the one that makes contact last. In the exemplary press of FIG. 1, a trailing edge making contact with inking roller 7 is also the trailing edge making contact with the printing medium 2.

One problem that can occur with such printing systems is the presence of an inking void near the trailing edge of a full tone relief feature making contact with the anilox roller. The inking void is typically recognized in the reproduced image on the printing medium as a substantial reduction in ink density in the void area relative to adjacent areas of the solid feature. In practice, an average reduction of 50% to nearly 100% is common in the void.

Interestingly, the problem seems to be restricted to full tone image features or nearly full tone image features (i.e. above 95% tonality). In other words, relief features (e.g. halftone dots) representing substantially less than full tone, typically will not show the presence of an inking void while full tone features on the same printing plate will. The inking void generally follows the outline of trailing edges of a full tone image feature. It generally does not appear on the leading edges or on edges that are substantially aligned with the printing direction.

Some prior art literature, such as the article “Increase Anilox pressure for trailing edge void problems”, by Cordes Porcher, in the October 2004 issue of Paperboard Packaging, discuss the problem and a solution involving controlling anilox roller pressure. Testing has confirmed that this can address the problem, but in general can result in decreased performance in reproduction of halftone (i.e. not full tone) relief features.

It is desirable, therefore, to find ways to reduce the occurrence of trailing edge inking voids in solid features without compromising the fidelity of halftone feature reproduction.

### SUMMARY OF THE INVENTION

The present invention provides a system and method for reducing the occurrence of an inking void in the vicinity of the trailing edge of a full tone image feature of an inked relief plate. According to one embodiment of the invention, a system produces or obtains original halftone data for an image to be reproduced. The system modifies halftone data associated with the full tone feature to modify the topography of the finished relief plate in order reduce the occurrence of a trailing edge inking void.

According to one aspect of the invention, the system determines a printing direction with respect to the image data to identify, for an intended press configuration, which parts of an image relief feature correspond to a trailing edge of contact with either an inking roller of the press or the printing medium processed by the press.

According to another aspect of the invention, the system modifies halftone data corresponding to a trailing edge portion of a full tone feature. According to one embodiment of this aspect of the invention, the system modifies halftone data by disabling a pattern of halftone pixels near the trailing edge of a full tone feature. According to one preferred embodiment, the pattern comprises a pattern of slits, arranged with a regular spacing and with the slits substantially aligned with the printing direction.

These and other aspects of the present invention are illustrated in the detailed description of the invention.

### BRIEF DESCRIPTION OF THE DRAWINGS

FIG. 1 is a prior art diagram illustrating an exemplary relief printing press.

FIG. 2 is a micrograph depicting a cross section of an exemplary printing plate relief feature.

FIG. 3 is a graph illustrating relief height variation as a function of distance from the trailing edge of the exemplary relief feature of FIG. 2.

FIG. 4 is a micrograph depicting a portion of a sheet printed by the exemplary relief feature of FIG. 2.

FIG. 5 is a graph illustrating printed ink density as a function of distance from the leading edge of the exemplary relief feature of FIG. 2.

FIG. 6 is a micrograph illustrating ink coverage for a portion of an exemplary printing plate.

FIG. 7 is a micrograph illustrating printed ink density reproduced by the printing plate example of FIG. 6.

FIG. 8 is a micrograph illustrating ink coverage for a portion of an exemplary printing plate according to the present invention.

FIG. 9 is a micrograph illustrating printed ink density reproduced by the printing plate example according to the present invention.

FIG. 10 is exemplary modified halftone data according to the present invention.

FIG. 11 is an exemplary relief printing system according to the present invention.

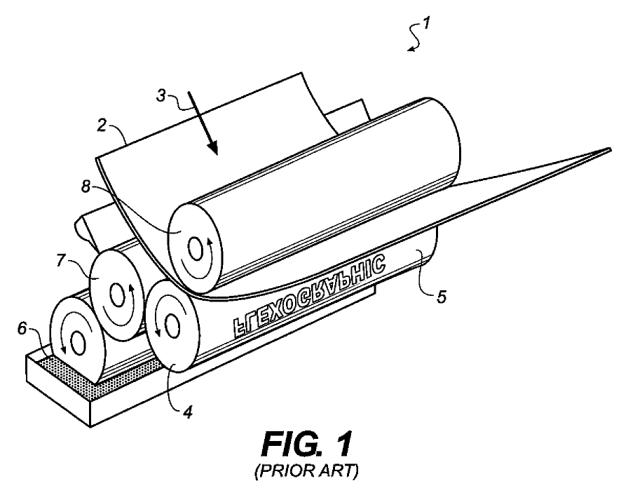

### DETAILED DESCRIPTION OF THE INVENTION

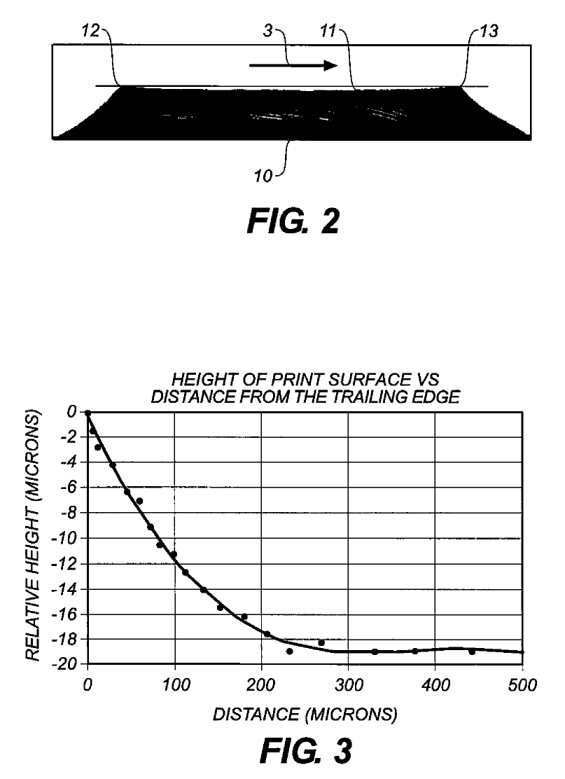

FIG. 2 is a micrograph depicting a cross section of an exemplary printing plate relief feature. The relief feature corresponds to a line element portion of an image reproduced in a flexographic plate through an analog production process (e.g. vacuum contact of an image mask during exposure). The image specifies a solid-tone line approximately 1.3 mm wide. The transverse cross section of the corresponding relief feature in the finished plate identifies the printing direction 3, leading edge 12 and trailing edge 13 of the feature. The top surface 11 of the relief feature is approximately 0.4 mm (17 mils) above the plate floor.

Many relief features produced on flexible plate media exhibit an increased relief height near leading edge 12 and trailing edge 13. This generally occurs whether the plate was made by an analog or a digital process with the magnitude of the increase varying significantly depending on the process conditions used.

FIG. 3 is a graph illustrating relief height variation as a function of distance from the trailing edge of the exemplary relief feature of FIG. 2. This illustrates that the magnitude of edge relief height can be at least 20 microns higher than the nominal height of top surface 11.

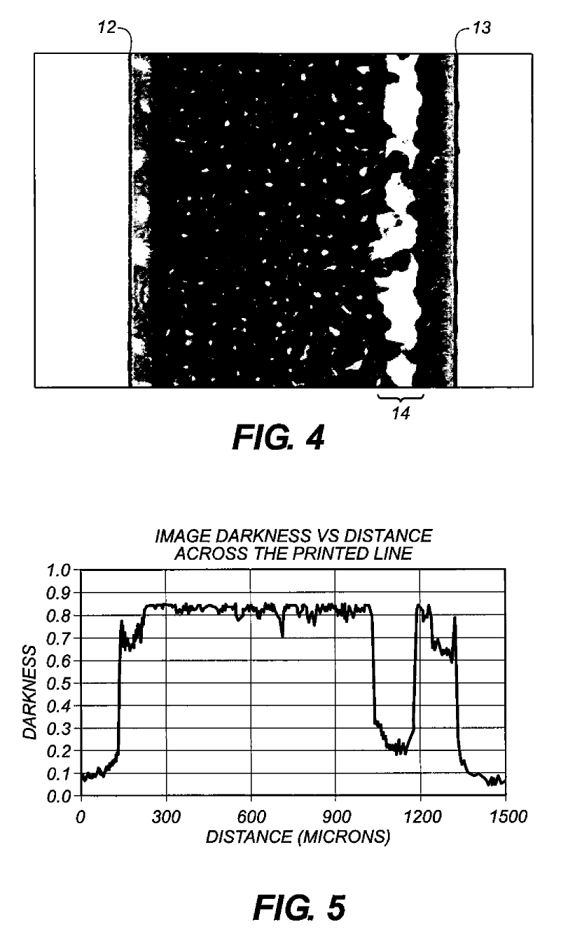

FIG. 4 is a micrograph depicting a portion of a sheet printed by the exemplary relief feature of FIG. 2. It illustrates that a substantial trailing edge inking void 14 exists along the length of the printed line. Trailing edge inking void 14 is separated from trailing edge 13 by an area that has substantially a solid printed ink density. Similarly, the central portion of the line is printed with a nearly solid ink density. Portions of the printed line immediately adjacent the leading edge 12 appear to have varying spatial density, resulting in the perception of a blurred leading edge 12. Trailing edge inking void 14, on the other hand, is very noticeable because of its size, consistency and surrounding full tone areas.

FIG. 5 is a graph illustrating printed ink density as a function of distance from the leading edge of the exemplary relief feature of FIG. 2. The graph of FIG. 5 represents an average of ink densities at various edge distances for a series of positions along the length of the printed line. It is clear from this graph that a reduction of approximately 75% in density occurs in trailing edge inking void 14.

It was believed that edge height variations could contribute to the presence of trailing edge inking voids 14 and experiments were conducted to try and reduce their magnitude. The most promising approach discovered was to introduce a pattern of holes in the solid halftone data near trailing edge 13. In preferred embodiments, the pattern comprised a series of fine slits (or linear indentations) near and substantially perpendicular to the trailing edge(s) of a relief feature. The slits represent a reduced relief height that may or may not extend to the floor of the printing plate.

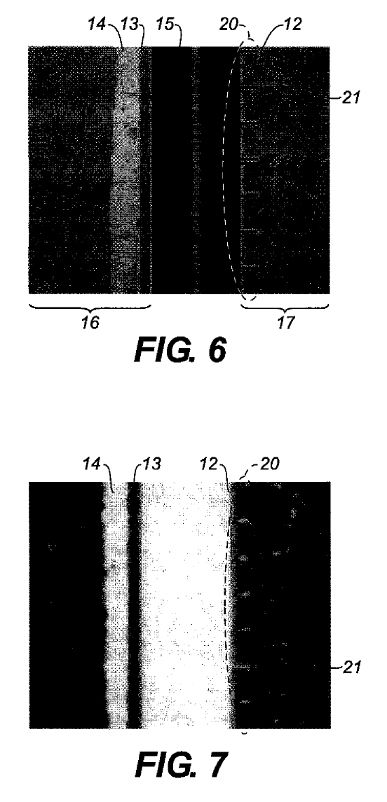

Experimentally, patterns having slits approximately 20-30 micron wide, 150-200 microns long and spaced 150-800 microns apart substantially reduced or eliminated the edge-void artifacts. Empirically it was observed that slit length to slit spacing ratios in the 0.25 to 1.00 range produced excellent results. In one preferred embodiment, slits have a regular spacing. In other embodiments, slits can have a randomized spacing. FIGS. 6-9 illustrate exemplary results of the present invention.

FIG. 6 is a micrograph illustrating ink coverage for a portion of an exemplary printing plate. The micrograph illustrates a plan view of a portion of two adjacent relief features representing full tone image lines. The two features are part of a printing plate 5 produced using a digital plate making process. The features are separated by a linear section of plate floor 15. Printing plate 5, as shown, is in a state where it has been inked and has not yet made contact with printing medium 2.

Trailing edge 13 of the left hand line feature is indicated. To the left of trailing edge 13, is a medium-colored area indicating the desired presence of ink. To the left of the medium-colored area is a light-colored area corresponding to trailing edge inking void 14. To the left of trailing edge inking void 14 is another properly inked area. The left hand feature thus illustrates the typical problem of trailing edge inking voids present on an inked plate.

Leading edge 12 of the right hand line feature is also indicated. For comparative purposes, the right hand relief feature was made with a pattern 20 comprising slits 21 established with an approximate width of 20 microns, an approximate length of 150 microns and an approximate spacing of 300 microns. The coloring indicates that, with the exception of slits 21, all areas of the right hand feature carry the desired amount of ink.

FIG. 7 is a micrograph illustrating printed ink density reproduced by the printing plate example of FIG. 6. Areas of higher printed ink density have dark color than areas of lower printed ink density. In particular, trailing edge inking void 14, the area corresponding to plate floor 15, and the areas corresponding to slits 21 have relatively low printed ink density.

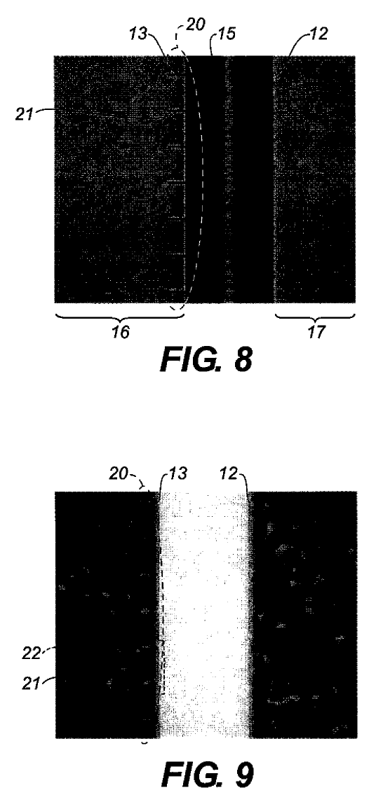

FIG. 8 is a micrograph illustrating ink coverage for a portion of an exemplary printing plate according to the present invention. Printing plate 5, depicted in FIG. 8 is similar to that of FIG. 6 except that pattern 20 has been established near trailing edge 13 of the left hand feature instead of near the leading edge 12 of the right hand feature. Noticeably absent from FIG. 8 is the trailing edge inking void 14. Even though pattern 20 has not been established for the right hand feature, no inking void is present near leading edge 12. Thus, establishing pattern 20 in the leading edge of a full tone feature appears to provide little benefit, but also does not seem to significantly impair the inking process.

FIG. 9 is a micrograph illustrating printed ink density reproduced by the printing plate example according to the present invention. As expected, a desirable printed ink density is created that corresponds to the ink distribution on plate 5 as depicted in FIG. 8.

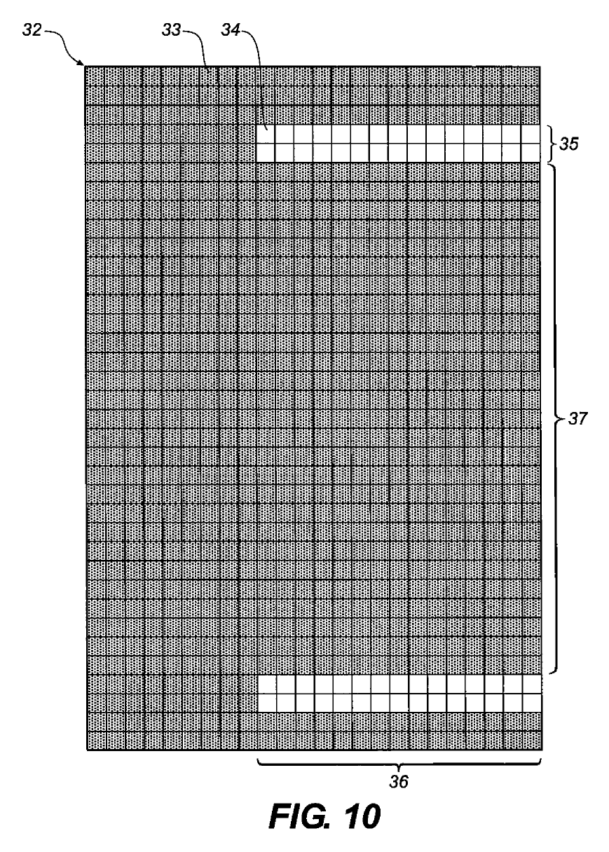

FIG. 10 is exemplary modified halftone data according to the present invention. Halftone image data 32 comprises a plurality of device pixels corresponding to area 22 of FIG. 9. Enabled halftone pixels 33 are depicted with a dark color. Disabled halftone pixels 34 are depicted with light color. Since, relief plates are often made with negative-image masks, the terms “enabled” and “disabled” can be confusing. In this application, “enabled halftone” refers to a halftone value that tends to produce an ink-carrying pixel location on printing plate 5.

Thus, original halftone data for area 22 would have included only “enabled” halftone data values. According to one embodiment of the present invention, pattern 20 has been created by disabling selected halftone data values near the trailing edge(s) of full tone image features.

For an imaging device, with pixel dimensions of approximately 10 microns per side, an exemplary slit width 35 comprises approximately 2 pixels, an exemplary slit length 36 comprises approximately 15 pixels, and an exemplary slit spacing 37 comprises approximately 30 pixels. For many plate making systems and plate precursors, a printing plate 5 made using halftone image data 32 will have relief profiles that are highly correlated with halftone image data 32.

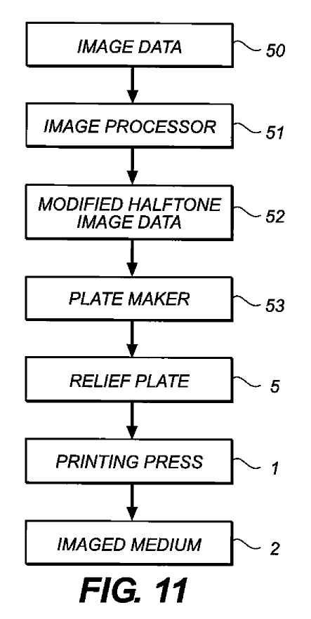

FIG. 11 is an exemplary relief printing system according to the present invention. Original image data 50 can be supplied to a computerized image processor 51 for processing. Original image data 50 may include continuous tone data, halftone data or both. In the former case, image processor 51 may perform a halftoning operation to produce original halftone data. According to one embodiment of the present invention, image processor 51 can modify the original halftone data to produce modified halftone image data 52 which includes disabled halftone pixels arranged according to pattern 20.

In some embodiments, this can be accomplished by performing image processing to identify trailing edges of full tone features of image data 50. This may include first determining a printing direction with respect to image data 50. For example, the printing system may be configured to rotate one or more of the image data 50, printing plate 5, and printing medium 2 with respect to printing direction 3 throughout the image processing, plate making and printing processes.

Identifying a trailing edge of a full tone image feature can be performed through a variety of well known image processing techniques. Application of pattern 20 to disable halftone pixels can then be applied through masking or other techniques.

Modified halftone image data 52 can then used by plate maker 53 to produce relief printing plate 5. This can include, for example, production of an image mask followed by one of a variety of exposure and processing process.

Finally, relief printing plate 5 can be used by a prior art printing press 1 to produce one or more copies of a printing medium 2 carrying ink to represent the original image.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### PARTS LIST

1 printing press
2 printing medium
3 printing direction
4 printing cylinder
5 printing plate
6 inking reservoir
7 inking roller
8 impression cylinder
11 top surface
12 leading edge
13 trailing edge
14 trailing edge inking void
15 plate floor
20 pattern
21 slit
22 area
32 halftone image data
33 enabled halftone pixel
34 disabled halftone pixel
35 slit width
36 slit length
37 slit spacing
50 image data
51 image processor
52 modified halftone image data
53 plate maker

1. A method for producing a relief plate, the method comprising:
obtaining image data for the relief plate wherein the image data specifies a full tone feature;
modifying halftone image data associated with the full tone feature to prevent an occurrence of a trailing edge void during inking of the relief plate; and
preparing the relief plate based on the modified halftone image data.

2. A method according to claim 1, the method also comprising:
determining a printing direction with respect to the image data; and
wherein modifying halftone image data associated with the full tone feature comprises modifying a portion of the full tone feature based on the printing direction.

3. A method according to claim 2 wherein modifying the portion of the full tone feature comprises modifying a trailing edge portion of the full tone feature.

4. A method according to claim 3 wherein modifying halftone image data comprises disabling a pattern of pixels in the halftone data corresponding to the trailing portion of the full tone feature.

5. A method according to claim 4 wherein the pattern comprises a plurality of slits substantially aligned with the printing direction.

6. A method according to claim 5 wherein a slit of the plurality of slits has a length of at least 150 microns.

7. A method according to claim 5 wherein the plurality of slits are arranged in a regular fashion with a spacing in the range of approximately 150-800 microns.

8. A method according to claim 5 wherein the plurality of slits are arranged in a regular fashion with a spacing and wherein the average length of the plurality of slits is in the range of 0.25-1.0 spacing times the spacing between slits.

9. A method according to claim 5 wherein a slit of the plurality of slits has a no larger than approximately 20 microns.

10. A method according to claim 5 wherein the plurality of slits are arranged in a randomized spacing between the slits.

11. A method according to claim 1, the method also comprising:
analyzing the image data to determine a subset of full tone features likely to produce relief edges with raised elevation; and
modifying halftone image data associated with only the identified subset of full tone features.

12. A relief printing plate for reproducing an image based on original image data, the plate comprising a full tone relief feature with a trailing edge wherein the trailing edge is identifiable based on an eligible orientation of the plate with respect to a printing direction of a printing press; and
wherein a portion of the solid relief feature proximal the trailing edge includes a pattern of indentations designed to reduce occurrence of a trailing edge inking void.

13. A system for producing a relief plate, the system comprising an image processor operative to:
obtain image data for preparing the relief plate wherein the image data specifies a full tone feature; and
modify halftone image data associated with the full tone feature to prevent an occurrence of a trailing edge void during inking of the relief plate.

14. A system according to claim 13, the system also comprising a plate maker operative to prepare the relief plate based on the modified halftone image data.

15. An image processor according to claim 13, the image processor also operative to:
determine a printing direction with respect to the image data; and
wherein modifying halftone image data associated with the full tone feature comprises modifying a portion of the full tone feature based on the printing direction.
